(19) United States
(12) Patent Application Publication
(10) Pub. No.: US 2009/0321973 A1
(43) Pub. Date: Dec. 31, 2009

(54) Method Of Partially Engraving Foamed Plastic Extrusions

(75) Inventor: Angelo Sudano, Quebec (CA)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ROYAL GROUP, INC., Atlanta, GA (US)

(21) Appl. No.: 12/555,625

(22) Filed: Sep. 8, 2009

Related U.S. Application Data
(62) Division of application No. 11/056,109, filed on Feb. 14, 2005.

(30) Foreign Application Priority Data
Sep. 23, 2004 (CA) 2482500

(51) Int. Cl. B29C 44/56; B29C 44/50

(52) U.S. Cl. 264/48

(57) ABSTRACT

A method of only partially engraving foamed plastic extrusions and foamed plastic extrusions so engraved, the method comprising formulating the plastic to leave residual foaming agents after extrusion and contacting one or both sides of the extrusion with an embossed engraving roller or rollers controlled to limit penetration and contact of the foamed plastic with the outer portions only of the roller embossment to activate residual foaming agents to foam the plastic around such penetrating portions.

### CROSS-REFERENCE TO RELATED APPLICATIONS

This application is a divisional application of U.S. patent application Ser. No. 11/056,109, filed Feb. 14, 2005, which is hereby incorporated by reference in its entirety.

### FIELD OF THE INVENTION

This invention relates to the art of engraving foamed plastic extrusions.

More particularly, the invention relates to providing foamed plastic extrusions such as blind slats or the like which are only partially engraved to uniquely present decorative designs or patterns which occupy only a portion of their width.

### BACKGROUND OF THE INVENTION

While foamed plastic extrusions such as blind slats louvers, frames, trim strips and the like have heretofore been engraved with decorative designs, it has been a requirement that the full surface of the extrusions be engraved to preclude their distortion and impairment of their surfaces and density where they have not been engraved. These problems have precluded the highly desirable decorative effect which it has been found can be obtained by only partially engraving these extrusions in such a way as to provide designs occupying only a portion of their width while leaving their surfaces and density where they have not been engraved unimpaired.

It is therefore the object of the present invention to solve the problems of only partially engraving foamed plastic extrusions.

It is a further object of the invention to enable the designs or patterns created by the partial engraving of the extrusions to be located at any position or positions between their width and to enable such partial engravings to be effected on the upper side or the lower side or on both the upper and lower sides of the extrusion whereby an infinite number of novel designs by partial extrusion can be obtained.

### SUMMARY OF THE PRESENT INVENTION

The invention resides in providing an engraving roller having the desired design embossed on a portion of its width, penetrating a foamed plastic extrusion formulated to have residual activatable foaming agents with the roller embossment which has been heated to a temperature of the order of 230 degrees F. to 300 degrees F. sufficient to activate the residual foaming agents. Penetration of the roller embossment is arranged to be limited so that only the outer portions thereof penetrate the foamed plastic of the extrusion. With this arrangement, the outer portions of the roller embossment cause the residual foaming agents to foam the plastic to precisely conform to the penetrating outer portions of the roller embossment leaving the remainder, that is, the nonengraved portions of the extrusion unaltered.

According to one aspect of the invention the heating of the roller embossment is effected by a hot air gun or guns. Alternatively, the roller itself may be heated by circulating hot oil to bring the embossment up to the required foaming agents activating temperature. In both cases, of course, only the outer portions of the roller embossment penetrate the foamed plastic of the extrusion.

It will be understood that since only the outer portions of the embossment of the roller penetrate the foamed plastic of the extrusion a space will be left in the valleys of the roller embossment for the escape of heat.

If the embossment on the roller is adjacent one side as opposed to being centrally located there may be a tendency to effect the straightness of the extrusion during the engraving operation and accordingly to correct this potential problem following the engraving the extrusion is preferably heated to a temperature of the order of about 150 degrees F. to 200 degrees F. This heating temperature is below any blowing agent activation temperature but softens the extrusion so that an operator can readily correct any distortion thereof as the extrusion is pulled to a cutting table where it can be cut off at the proper lengths.

These and other objects and features will be apparent from the following detailed description taken in conjunction with the accompanying drawings.

### BRIEF DESCRIPTION OF THE DRAWINGS

FIG. 1 is a simplified perspective view of an extruder showing a generally flat extruded strip of foamed plastic being pulled from the extruder through an extrusion die, a calibrator, and a vacuum operated water cooling station;

FIG. 2 shows the foamed plastic extrusion being pulled through the engraving station by the puller after which it is fed through a cutting station onto a collecting table;

FIG. 3 is an enlarged broken away view of the engraving roller embossed with a design showing the outer portions of the embossment penetrated into the foamed plastic of the extrusion to the maximum depth to which they are limited so that all other roller surfaces are maintained out of contact with the extrusion;

FIG. 3A shows the bottom roller 12 of FIG. 3 replaced by an engraving roller 12′ having a design the same as design 15 embossed thereon;

FIG. 4 is a fragmented section of the roller after the outer portions of the embossment have left the extrusion showing the extrusion grooved or engraved with an accurate reproduction of the roller embossment design;

FIG. 5 is a plan view of the extrusion after it has been engraved;

FIG. 6 is a cross section view taken along lines 6-6 of FIG. 5;

FIG. 7 is an elevational view of an alternative engraving station in which the engraving roller is heated with circulating oil; and

FIG. 8 is a perspective view of the roller arrangement in FIG. 7.

### DETAILED DESCRIPTION ACCORDING TO THE PREFERRED EMBODIMENTS OF THE PRESENT INVENTION IN WHICH

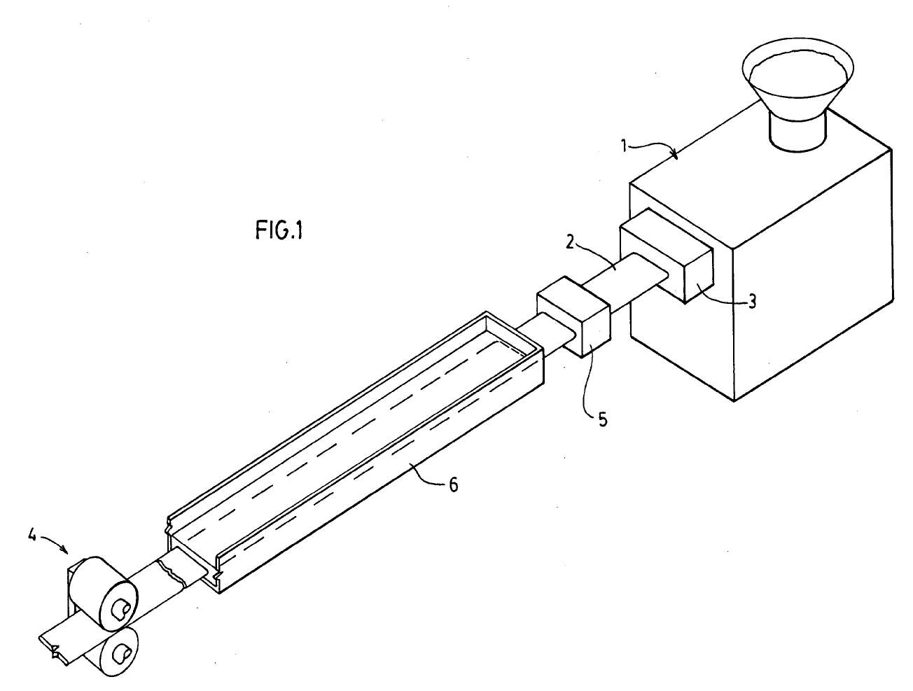

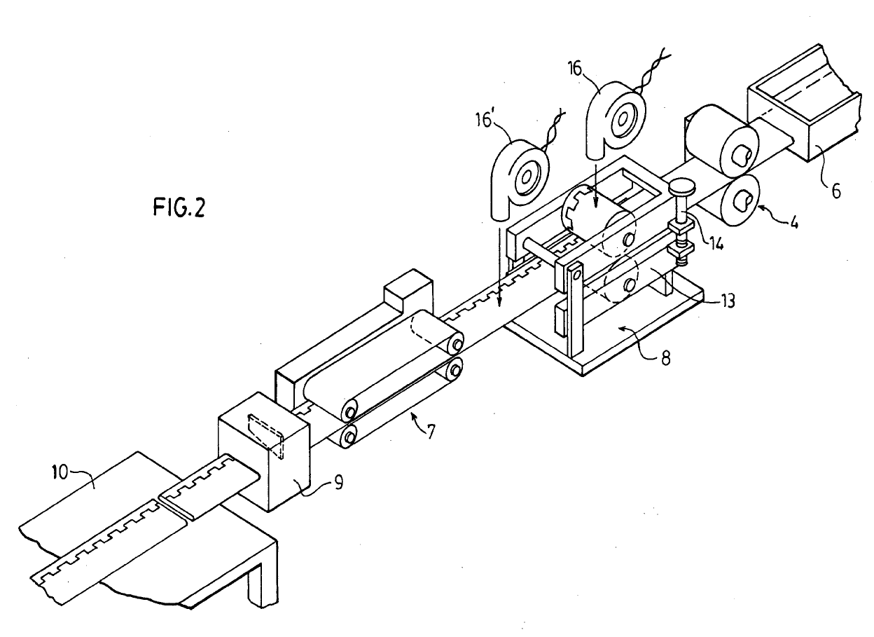

With reference to FIGS. 1 and 2 a conventional extruder 1 is illustrated, the extruder being operated at a temperature between about 300 degrees F. and 360 degrees F. from which a flat strip 2 of foamed plastic is pulled from a die 3, a calibrator 5, a vacuum operated water cooling station 6, and smoothing rollers 4.

The strip 2 is formed from foamed plastic material formulated with sufficient blowing agents to leave some residual unactivated or not fully activated blowing agents in the foamed plastic after the extrusion process. A PVC containing between 0.2 p.p.h. to 0.5 p.p.h. of organic type blowing agents and between 0.5 p.p.h. to 1.2 p.p.h. of inorganic blowing agents has been found very satisfactory.

After passing through the water cooling station 6 as shown in FIG. 2, the extrusion 2 is pulled by a puller 7 between smoothing rollers 4 and through an engraving station generally designated at 8. Following the engraving, the strip 2 is delivered from the puller through a cutting station 9 to be collected on a collector table 10.

The engraving station 8, illustrated in FIG. 2, comprises an upper heated engraving roller 11 and an under supporting roller 12 with the extrusion 2 being fed therebetween. The rollers 11 and 12 are rotatably supported-in a clamping frame 13 which has an adjuster 14 to control the clamping or squeezing pressure of the rollers on the extrusion.

The engraving roller 11 has the desired design, indicated generally at 15, embossed thereon and is heated by a hot air gun 16 to bring the temperature of the roller embossment up to between about 230 degrees F. and 300 degrees F.

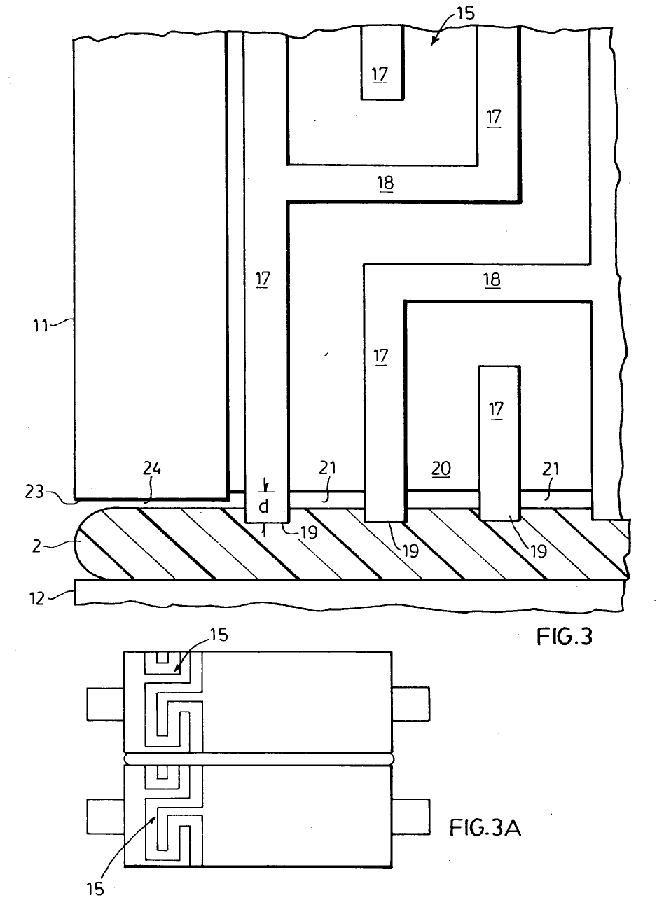

As illustrated in FIG. 3, the particular illustrated design 15 embossed on the engraving roller 11 comprises circumferentially extending projections 17 and projections 18 extending in a direction transversely of the projections 17, that is, parallel to the roller axis.

As can be seen from FIG. 3 these projections project outwardly beyond the body of the roller with their outer surfaces or peaks 19 projecting a distance “d” beyond the body portion 20 of the roller 11.

FIG. 3 illustrates the depth of penetration of the projections 17 and 18 of the embossed engraving roller design 15 during the engraving process. As will be seen, only the peaks 19 and the outer portions adjacent the peaks project into the foamed plastic of the extrusion.

Thus, it will be seen that the depth of penetration of the embossment projections is substantially less than the distance “d” leaving a space 21 between the surface of the extrusion 2 and the body portion 20 of the roller 11.

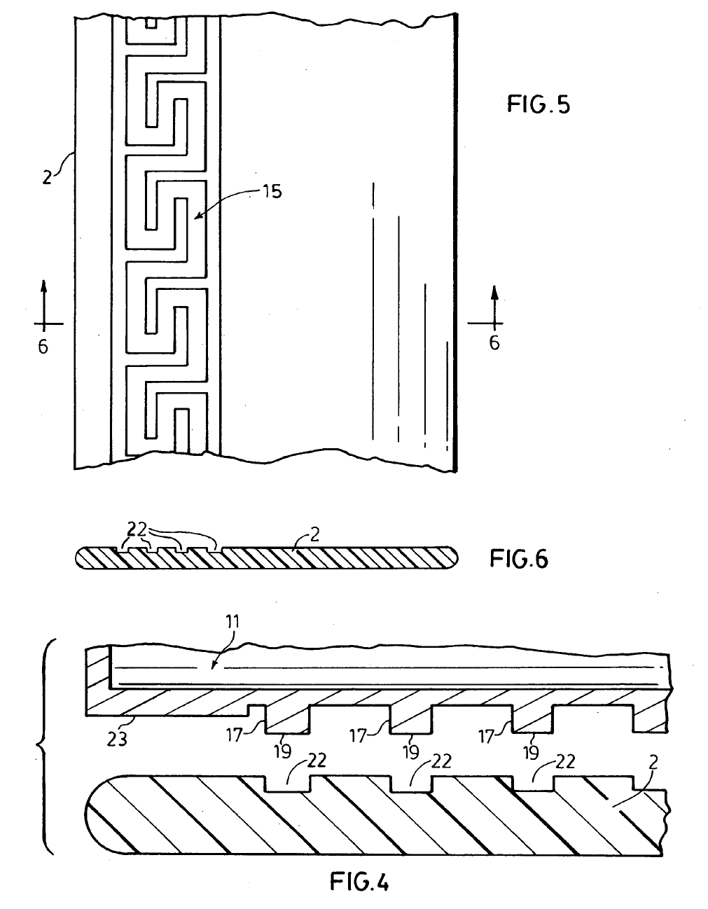

Since the temperature of these projections 17 and 18 is between about 230 degrees F. and 330 degrees F., their heat is sufficient to activate the residual unactivated or activatable blowing agent or agents causing the plastic in these penetrated areas to foam and flow around the penetrating portions of the projections to precisely conform the grooves 22 engraved in the extrusion to the shape of the embossed roller design 15 as shown in FIG. 4.

As shown in FIG. 3, the space 21 left between the extrusion 2 and the body portion 20 of roller 11 during the engraving operation not only prevents contact of this body portion with the extrusion which would cause unwanted activation of residual blowing agents but it further provides an escape route between the roller projections 17 and 18 for the escape of heat trapped between the projections to ensure there is no unwanted blowing agent activation.

Also as shown in FIG. 3, the outer peripheral surface 23 of the roller 11 is also maintained out of contact with the extrusion 2 being separated therefrom by a space 24 which provides for lateral heat escape.

Upon being pulled clear of the engraving roller 11 and under roller 12, the extrusion appears as in FIG. 5 having an engraved design 15′ which is a replica or mirror image of the design 15 embossed on the engraving roller. In an exemplary embodiment, the extrusion has a smooth surfaced border on each side of the engraved design or pattern.

It is important to note that where the extrusion 2 is to be used to produce self supporting products which require rigidity such as blind slats or louvers that in addition to ensuring that the activatable blowing agents are only activated by the penetrating portions 17 and 18 of the engraving roller but that the extrusions have adequate thickness and density for its purpose. If any of the residual blowing agents are activated in the non-engraved portions of the extrusion, their density would be reduced. The density of a self supporting slat extrusion is very critical as reduction in the density will drastically reduce the horizontal rigidity or vertical hanging characteristics of the slat. If the density of such a slat extrusion, for example, is reduced below a density between about 45 percent to 55 percent of that of a solid slat extrusion having the same thickness, the slat will show bowing characteristics when exposed to a heat source such as heat build up from the sunlight between the blind and the window or any other type of heat source such as interior baseboard heaters or other sources of heat.

However, engraved products that do not require any form of rigidity because they are secured to rigid surfaces may have much lower densities as well as being thinner. Such products include door moldings or window moldings that are secured in position and serve purely decorative purposes.

In the application of the invention illustrated in FIGS. 1 and 2 the engraved design is adjacent one end of the engraving roller 11 to locate the design near one side of the extrusion 2. The penetrating pressure of the embossments of the engraving roller near one side may cause some distortion or twisting of the extrusion 2 as it leaves the engraving station 8. To ensure no problem is encountered, as illustrated in FIG. 2, a hot air gun 16′ is arranged to direct heat on the extrusion after it leaves the engraving station to heat the extrusion to a temperature of the order of 150 degrees F. to 200 degrees F. Heated to these temperatures, the extrusion is workable by an operator to straighten same. These temperatures are, of course, well below any temperature that would cause any reactivation of any residual unactivated blowing agent.

It will be understood that the engraving roller 11 may have the desired design embossed thereon at any position across its width or even having more that one design engraved thereon. As shown in FIG. 3A, the bottom roller 12 may be replaced by an embossed bottom roller 12′ to produce an engraved design on the undersurface of the extrusion as well as on its top surfaces. In an exemplary embodiment, the engraved design on the undersurface of the extrusion is in registration with the engraved design on the opposite surface.

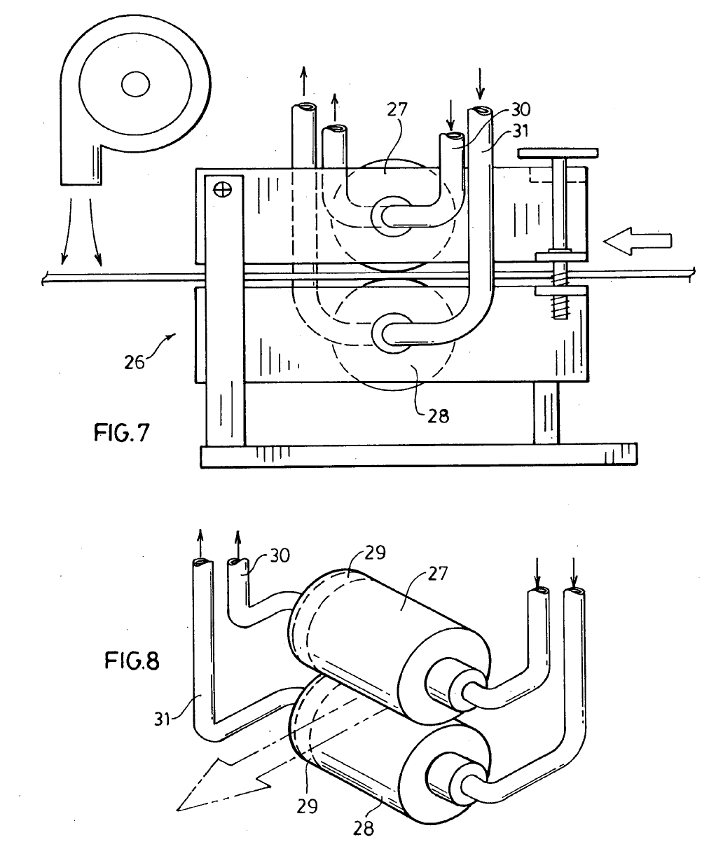

The embossed design on the engraving roller or rollers may be brought up to the blowing agent activating temperature in other ways than with a hot air gun as illustrated in FIG. 7. FIG. 7 shows an engraving station 26 which has an upper engraving roller 27 and a lower engraving roller 28 both with centrally located designs 29 embossed thereon.

In this case, the engraving rollers 27 and 28 are heated by circulating hot oil therethrough by means of piping 30 and 31 respectively. As before, only the hot outer most portions of the embossed designs 29 penetrate into the foamed plastic of the extrusion 3.

It will be understood that the width and thickness of the foamed plastic strip 2 can be selected as desired and, using the principles of the invention as described above, multiple designs can be engraved on the extrusion spaced across its width.

While PVC foamed material has been found to be particularly useful, other materials with similar characteristics or properties, more specifically with “absorbing” type characteristics, such as polystyrene, that can retain the engraving can be used. These or other type materials with similar properties or characteristics can be used with a cap stock or as a cap stock. In this connection, the invention is applicable to engrave an extrusion of a non-foamed materials such as ABS, partially or totally encased in a foamed plastic material to produce a partially engraved product having a reinforcing core.

Although various preferred embodiments of the present invention have been described in detail, it will be appreciated by those skilled in the art that variations may be made utilizing the principles of the invention and without departing from the scope of the appended claims.

What is claimed is:

1. A method of providing a partially engraved generally flat foamed plastic extrusion comprising:
providing a foamable plastic composition comprising a blowing agent having an activation temperature range;
extruding said foamable plastic composition to produce a generally flat foamed plastic extrusion having a residual amount of unactivated blowing agent remaining on a first surface thereof;
providing a first heated engraving roller having a body portion and at least one projection that projects above the body portion by a distance d₁, wherein said at least one projection of said first heated engraving roller has an engraving temperature that is within the activation temperature range;
contacting said first surface of said foamed plastic extrusion with the at least one projection of said first heated engraving roller so that said at least one projection penetrates the first surface of said foamed plastic extrusion, creating an engraved portion thereon,
whereby the at least one projection penetrates said first surface of said foamed plastic extrusion to a depth that is less than d₁ so that said body portion of said first heated engraving roller does not contact said first surface of said foamed plastic extrusion;
whereby contacting said first surface of said foamed plastic extrusion with said at least one projection activates the residual unactivated blowing agent in the engraved portion of said first surface, causing the plastic composition in the engraved portion to foam and precisely conform to said least one projection without outward displacement of the plastic composition beyond the first surface of said foamed plastic extrusion, thereby creating a groove having a mirror image of the design formed by said at least one projection of said first heated engraving roller; and
whereby in all non-engraved portions of said first surface of said foamed plastic extrusion, the residual amount of unactivated blowing agent remains substantially unactivated.

2. The method of claim 1, wherein the activation temperature range is about 230 degrees F. to about 300 degrees F.

3. The method of claim 1, wherein a portion of the first surface of the foamed plastic extrusion that is adjacent the groove is smooth.

4. The method of claim 1, further comprising heating said foamed extrusion to a manipulation temperature that is sufficient to enable the extrusion to be manipulated by an operator, but is below the activation temperature range.

5. The method of claim 4, wherein said manipulation temperature is between about 150 degrees F. and about 200 degrees F.

6. The method of claim 1, wherein said first heated engraving roller is heated with a hot air gun.

7. The method of claim 1, wherein said first heated engraving roller is heated by circulating hot oil therethrough.

8. The method of claim 1, comprising:
providing a second roller adjacent said first heated embossing roller;
whereby contacting said first surface of said foamed plastic extrusion with the at least one projection comprises passing the foamed plastic extrusion between said first heated engraving roller and said second roller so that a second surface of said foamed plastic extrusion contacts at least a portion of said second roller.

9. The method of claim 8, whereby the second roller and the first heated embossing roller exert a pressure upon the foamed plastic extrusion.

10. The method of claim 8, wherein said second roller comprises a second heated engraving roller having a body portion and at least one projection that projects above the body portion by a distance d₂, wherein said at least one projection of said second heated engraving roller has an engraving temperature that is within the activation temperature range;
wherein said method further comprises
contacting said second surface of said foamed plastic extrusion with the at least one projection of said second heated engraving roller so that said at least one projection penetrates the second surface of said foamed plastic extrusion, creating an engraved portion thereon,
whereby the at least one projection of said second heated engraving roller penetrates said second surface of said foamed plastic extrusion to a depth that is less than d₂ so that said body portion of said second heated engraving roller does not contact said second surface of said foamed plastic extrusion;
whereby contacting said second surface of said foamed plastic extrusion with said at least one projection activates the residual unactivated blowing agent in the engraved portion of said second surface, causing the plastic composition in the engraved portion to foam and precisely conform to said least one projection without outward displacement of the plastic composition beyond the second surface of said foamed plastic extrusion, thereby creating a groove having a mirror image of the design formed by said at least one projection of said second heated engraving roller; and
whereby in all non-engraved portions of said second surface of said foamed plastic extrusion, the residual amount of unactivated blowing agent remains substantially unactivated.

11. The method of claim 10, further comprising heating said foamed extrusion to a manipulation temperature that is sufficient to enable the extrusion to be manipulated by an operator, but is below the activation temperature of said blowing agent.

12. The method of claim 11, wherein said manipulation temperature is between about 150 degrees F. and about 200 degrees F.

13. The method of claim 10, wherein at least one of said first and second heated engraving roller is heated with a hot air gun.

14. The method of claim 10, wherein at least one of said first and second heated engraving roller is heated by circulating hot oil therethrough.

15. The method of claim 10, wherein a portion of the second surface of the foamed plastic extrusion that is adjacent the groove is smooth.
